(19) United States
(12) Patent Application Publication
(10) Pub. No.: US 2017/0323396 A1
(43) Pub. Date: Nov. 9, 2017

(54) Policy Driven Payroll Engine

(71) Applicant: ADP, LLC, Roseland, NJ (US)

(72) Inventors: Dimitry Plotko, Alpharetta, GA (US); Walter Jacobus Van den Heever, Longmont, CO (US); Johann Heinrich Portwig, Alpharetta, GA (US)

(21) Appl. No.: 15/147,096

(22) Filed: May 5, 2016

(51) Int. Cl. G06Q 40/00

(52) U.S. Cl. CPC G06Q 40/125

(57) ABSTRACT

A method and apparatus for running a payroll. The method identifies a policy instance for an employee by a computer system, wherein the policy instance includes a group of execution units in the computer system that implements a group of rules for a policy with respect to running the payroll for the organization. Further, the method identifies data for the employee by the computer system. Yet further, the method processes the data in the group of execution units in the computer system to run the payroll for the employee, wherein the group of execution units is configured with instance-specific information for the policy instance to process the data for the payroll using the group of rules for the policy.

### BACKGROUND INFORMATION

### 1. Field

The present disclosure relates generally to an improved computer system and, in particular, to a method and apparatus for a policy driven payroll engine. Still more particularly, the present disclosure relates to a method and apparatus for an improved computer system that processes a payroll using one or more rules in a policy.

### 2. Background

Information systems are used for many different purposes. For example, an information system may be used by a human resources department to maintain benefits and other records about employees. For example, the human resources department may manage health insurance, wellness plans, and other programs in an organization using the information system.

As another example, the information system may be used to run a payroll to generate paychecks for the employees in the organization. The information system in the form of a payroll processing system performs functions, such as calculating salary payments, bonuses, deductions, withholdings, taxes, and other suitable functions involved with running the payroll for the organization.

Different departments in the organization may have responsibilities that impact payroll processing. For example, a benefits department in the organization may have a retirement benefits policy that is used to manage retirement benefits. This department may manage eligibility, vesting schedules, withholdings, and other items relating to the retirement benefits.

As another example, the human resources department may have a policy for uniform benefits. The human resources department may identify which employees may be eligible to receive a uniform allowance for dress codes for a particular position. The policy may define who is eligible for a uniform allowance, how claims are submitted, and how credits may be obtained.

Different policies in the different departments result in reimbursements, deductions, bonuses, and other items that are taken into account when processing the payroll. The payroll impact may be an effect on the employee's net pay, tax applicable earnings, payments to third parties, and submissions to authorities. Each of these different departments may have information systems that generate deductions, reimbursements, withholdings, or other items that are used in running the payroll.

Configuring an information system to implement the policy in the organization is complex and time-consuming. For example, for organizations having different geographic locations, the policies for running the payroll may be dependent on laws for a particular geographic location, such as a city, a state, or a country. With this situation, different information systems for the payroll are often used for the different geographic locations.

This and other complexities often involve utilizing a consultant. The consultant works with people in the organization to identify the policies relating to the payroll and implement those policies in one or more information systems by writing code, setting parameters, or performing other operations in the information system.

Therefore, it would be desirable to have a method and apparatus that take into account at least some of the issues discussed above, as well as other possible issues. For example, it would be desirable to have a method and apparatus that overcome a technical problem with the complexity of configuring an information system to implement a business policy in an organization.

### SUMMARY

An embodiment of the present disclosure provides a payroll processing system. The payroll processing system comprises a group of policy instances and a payroll processor. The group of policy instances implements a group of rules for a group of policies used for running a payroll for an organization. The payroll processor selects a policy instance from the group of policy instances for running the payroll. Further, the payroll processor processes the data in a group of execution units in the policy instance, wherein the group of execution units is configured with instance-specific information for the policy instance to process the data for the payroll using the group of rules for a policy implemented using the policy instance.

Another embodiment of the present disclosure provides a method for running a payroll. The method identifies a policy instance for an employee by a computer system, wherein the policy instance includes a group of execution units in the computer system that implements a group of rules for a policy with respect to running the payroll for an organization. Further, the method identifies data for the employee by the computer system. Yet further, the method processes the data in the group of execution units in the computer system to run the payroll for the employee, wherein the group of execution units is configured with instance-specific information for the policy instance to process the data for the payroll using the group of rules for the policy.

Yet another embodiment of the present disclosure provides a method for creating a policy instance for running a payroll. The method identifies a policy template for a policy for processing the payroll. Further, the method identifies instance-specific information used by a group of execution units defined in the policy template to process the payroll. Yet further, the method creates the policy instance from the policy template using the group of execution units and the instance-specific information, wherein the policy instance is used to run the payroll for an employee.

Still another embodiment of the present disclosure provides a computer program product for running a payroll. The computer program product comprises a computer readable storage media, first program code, second program code, and third program code. The first program code, the second program code, and third program code are stored on the computer readable storage media. The first program code identifies a policy instance for an employee, wherein the policy instance includes a group of execution units in a computer system that implements a group of rules for a policy with respect to running the payroll for an organization. The second program code identifies data for the employee. The third program code processes the data in the group of execution units to run the payroll for the employee, wherein the group of execution units is configured with instance-specific information for the policy instance to process the data for the payroll using the group of rules for the policy.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is a block diagram of a policy framework in accordance with an illustrative embodiment;

FIG. 2 is a block diagram of an information environment in accordance with an illustrative embodiment;

FIG. 3 is a block diagram of a taxonomy for payroll templates in accordance with an illustrative embodiment;

FIG. 4 is a block diagram of a policy template in accordance with an illustrative embodiment;

FIG. 5 is a block diagram of dataflow used to create a policy instance from a policy template in accordance with an illustrative embodiment;

FIG. 6 is a block diagram of an execution unit in accordance with an illustrative embodiment;

FIG. 7 is a block diagram of dataflow of running a payroll in accordance with an illustrative embodiment;

FIG. 8 is an illustration of a policy engine in accordance with an illustrative embodiment;

FIG. 9 is a flowchart of a process for running a payroll in accordance with an illustrative embodiment;

FIG. 10 is a more detailed flowchart of a process for running a payroll in accordance with an illustrative embodiment;

FIG. 11 is a flowchart of a process for creating a policy template in accordance with an illustrative embodiment;

FIG. 12 is a flowchart of a process for creating a policy instance in accordance with an illustrative embodiment;

FIG. 13 is a more detailed flowchart of a process for creating a policy instance in accordance with an illustrative embodiment; and

FIG. 14 is a block diagram of a data processing system in accordance with an illustrative embodiment.

### DETAILED DESCRIPTION

The illustrative embodiments recognize and take into account one or more different considerations. For example, the illustrative embodiments recognize and take into account that, in addition to time and complexity of configuring information systems in an organization for running a payroll, the different systems often do not provide a seamless process in running the payroll. The illustrative embodiments recognize and take into account that different information systems may have different terminology for the different applications running on the information systems. As a result, users of the information systems are required to learn the terminology for each of the different applications.

Further, the illustrative embodiments recognize and take into account that configuring currently available information systems requires a technical knowledge of the information systems and applications that run on the information systems. Also, the illustrative embodiments recognize and take into account many applications that do not provide an ability to control as many details as needed to implement policies for the organization in a desired manner. The illustrative embodiments recognize and take into account that this situation may result in the organization changing or omitting portions of a policy when using a particular application.

Further, many information systems used to run the payroll are hardcoded. In other words, the applications or other software for running the payroll are customized or configured to meet the policies of a particular organization. As a result, if the policies in the organization change, reconfiguration of the applications or other software may take more time than desired. Thus, a technical problem is present with the time and effort needed to change the applications or other software for running the payroll when the policies within the organization change.

Thus, the illustrative embodiments provide a method and apparatus for running the payroll in the organization. In one illustrative example, a payroll processing system comprises a group of policy instances and a payroll processor. The group of policy instances implements a group of rules for a group of policies used for running the payroll for the organization. The payroll processor selects a policy instance from the group of policy instances for running the payroll for an employee in the organization; identifies data for the employee for use in running the payroll; and processes the data in a group of execution units in the policy instance. The group of execution units is configured with instance-specific information for the policy instance to process the data for the payroll using the group of rules for the policy. In the illustrative examples, the running of the payroll may include more than one policy instance. In this case, each of the policy instances is processed to run the payroll for an employee.

As used herein, “a group of”, when used with respect to items, mean one or more items. For example, “a group of policy instances” is one or more policy instances.

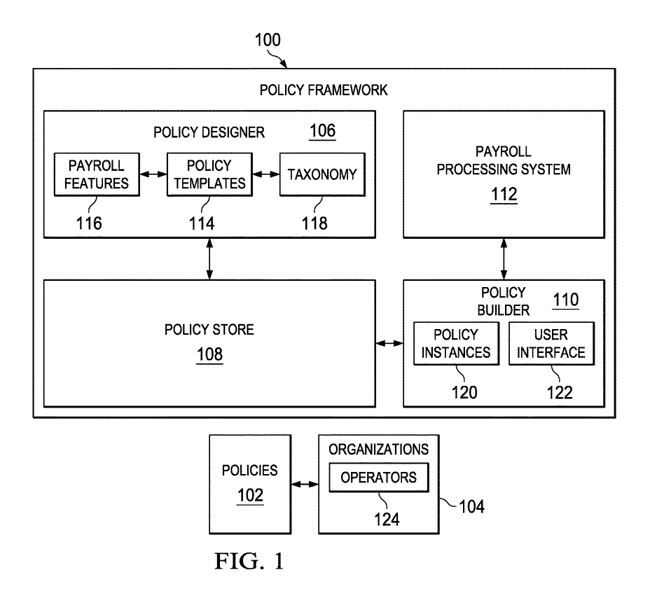

With reference now to the figures and, in particular, with reference to FIG. 1, a block diagram of a policy framework is depicted in accordance with an illustrative embodiment. In this depicted example, policy framework 100 is an example of a structure in which policies 102 may be implemented by organizations 104.

As depicted, policy framework 100 includes policy designer 106, policy store 108, policy builder 110, and payroll processing system 112.

Policy designer 106 creates policy templates 114 that implement policies 102. Policy templates 114 represent payroll features 116 that may be implemented by organizations 104. For example, a payroll feature in payroll features 116 may include, for example, retirement savings, 401(k) employer matches, tax withholdings, reimbursements, reporting, vacation time, and other suitable features that are used by organizations 104 in running a payroll.

In this illustrative example, policy designer 106 manages policy templates 114. The management of policy templates 114 includes at least one of creating, modifying, deleting, or organizing policy templates 114.

In this illustrative example, policy templates 114 are organized into taxonomy 118. Taxonomy 118 provides a logical classification of policy templates 114. The classification may include, for example, categories with subcategories. For example, taxonomy 118 may include categories, such as payees, earnings, deductions, taxes, reporting, payroll processes, and other types of categorizations for policy templates 114. These categorizations may include one or more layers of subcategories to form a tree-like structure that organize policy templates 114 in taxonomy 118.

Policy store 108 provides organizations 104 access to policy templates 114. For example, policy store 108 may be a website that may be accessed by organizations 104. Policy store 108 provides organizations 104 an ability to search for and purchase payroll features 116.

In this illustrative example, policy builder 110 may be used by organizations 104 to access policy store 108 and purchase one or more of payroll features 116. Further, policy builder 110 also provides a mechanism for implementing policy templates 114 corresponding to payroll features 116 that organizations 104 have selected for use.

The implementation of payroll features 116 by organizations 104 results in policy instances 120. In this illustrative example, policy builder 110 provides user interface 122 to operators 124 in organizations 104 to create policy instances 120 from policy templates 114 from payroll features 116 selected by operators 124 in organizations 104.

As depicted, payroll processing system 112 is used for payroll processing using policy instances 120. In this manner, one or more components in policy framework 100 provide a technical solution to overcome the technical problem with the complexity of configuring an information system to implement a policy in an organization. For example, different policy instances may be created each time a change is desired in the policies of the organization. This type of change does not require reworking the entire payroll system for the organization. A policy instance is a self-contained unit representing the policy for the organization. Thus, the use of policy templates corresponding to the policies allows for changes in individual policies to be made.

In policy framework 100, policy designer 106, policy store 108, policy builder 110, and payroll processing system 112 are physical hardware components that also may include software. For example, policy designer 106, policy store 108, policy builder 110, and payroll processing system 112 may be implemented using one or more computer systems.

A computer system is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or other suitable data processing systems.

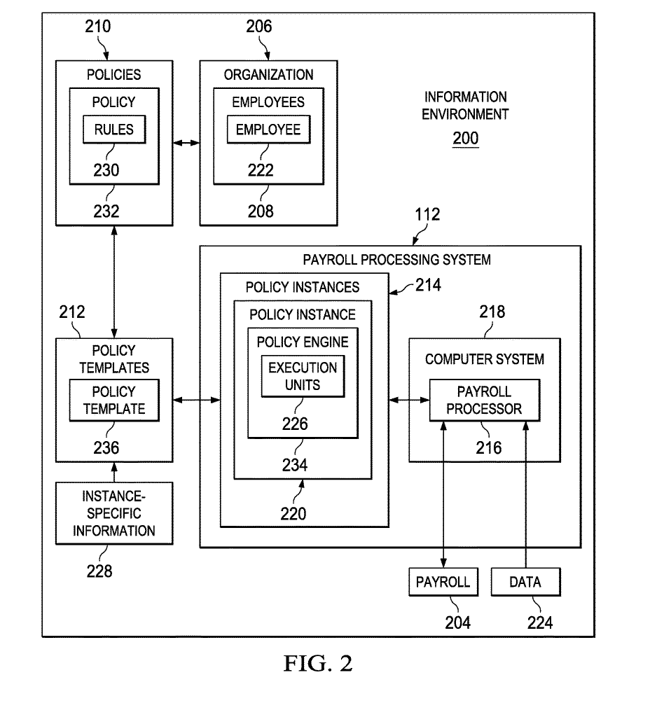

With reference next to FIG. 2, a block diagram of an information environment is depicted in accordance with an illustrative embodiment. In the illustrative examples, the same reference numeral may be used in more than one figure. This reuse of a reference numeral in different figures represents the same element in the different figures.

In this depicted example, information environment 200 includes payroll processing system 112 in FIG. 1. As depicted, payroll processing system 112 runs payroll 204 for organization 206.

In the illustrative example, payroll 204 is a process for identifying payment for employees 208 in organization 206. For example, payroll 204 may be performed to identify a payment for employees 208 in organization 206 using employment-related compensation, benefits, associated statutory and other deductions. Organization 206 may take different forms. For example, organization 206 may be selected from one of a company, a partnership, a charity, an educational group, a social group, a team, a city, a group of employees, a union, a government agency, or some other suitable type of organization.

As depicted, organization 206 has policies 210. A policy in policies 210 comprises one or more rules. As depicted, policies 210 define rules for how payroll 204 should be run for employees 208. Each policy in a group of policies 210 has one or more rules. A policy in policies 210 is selected from one of a uniform policy, a regular pay policy, a union policy, a retirement savings policy, a pension policy, an overtime policy, or some other suitable type of policy.

In the illustrative example, policy templates 212 are present for policies 210 that are implemented for use in payroll processing system 112. In this example, a group of policy templates 212 is a portion of policy templates 114 in FIG. 1 that have been selected for use by organization 206.

Policy templates 212 are frameworks for implementing policies 210 in payroll processing system 112 when running payroll 204 for organization 206. A policy template in policy templates 212 may be completed for use in implementing a policy in policies 210.

As depicted, the group of policy templates 212 may be implemented to form a group of policy instances 214. The group of policy instances 214 is an instantiation of the group of policy templates 212. The group of policy instances 214 implements a group of rules for the group of policies 210 used for running payroll 204 for organization 206. In other words, a policy instance in the group of policy instances 214 is a copy of a policy template in the group of policy templates 212 that has been configured to implement a particular policy for organization 206. In other words, information, options, or other changes or selections are made to the copy of the policy template to form the policy instance. The policy template remains unchanged for the creation of additional policy instances.

As depicted, payroll processor 216 in payroll processing system 112 runs payroll 204. Payroll processor 216 may be implemented in software, hardware, firmware, or a combination thereof. When software is used, the operations performed by payroll processor 216 may be implemented in program code configured to run on hardware, such as a processor unit. When firmware is used, the operations performed by payroll processor 216 may be implemented in program code and data and stored in persistent memory to run on a processor unit. When hardware is employed, the hardware may include circuits that operate to perform the operations in payroll processor 216.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors. In this illustrative example, payroll processor 216 is located in computer system 218 in payroll processing system 112.

In running payroll 204, payroll processor 216 selects policy instance 220 from the group of policy instances 214 for running payroll 204 for employee 222 in employees 208 in organization 206. Payroll processor 216 identifies data 224 for employee 222 for use in running payroll 204. In this illustrative example, payroll processor 216 selects policy instance 220 using at least one of an identification of an employee, a group to which the employee belongs, or in some other suitable manner. This information may be received as an input to payroll processor 216.

For example, payroll processor 216 may receive identification information for a group of employees 208 that are to be processed for payroll 204. In another example, this information may be in data 224 identified for employee 222. Data 224 used by payroll processor 216 may be located in a data structure, such as a table, a database, a flat file, or some other suitable type of data structure.

Payroll processor 216 processes data 224 in a group of execution units 226 in policy instance 220. The group of execution units 226 is configured with instance-specific information 228 for policy instance 220 to process data 224 for payroll 204 using a group of rules 230 for policy 232 in policies 210 implemented using policy instance 220.

In this example, the group of execution units 226 forms policy engine 234 that implements the group of rules 230 for policy 232 for running payroll 204. The group of execution units 226 may be comprised of program code in a device-specific language. A device-specific language is the language that a particular device uses to operate. Applications written to run on a device are written in the language that the device is designed or configured to use.

Policy template 236 is a template for policy 232 in this illustrative example. As depicted, policy instance 220 is formed from policy template 236 in the group of policy templates 212 using instance-specific information 228. Instance-specific information 228 comprises at least one of a parameter, a table, a database, a value, a formula, a policy data model, a statutory rule, or some other information that is specific to the manner in which policy 232 is implemented for organization 206.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, data 224 is information about employee 222 used by payroll processor 216 to run payroll 204 for employee 222. Data 224 may be selected from at least one of a salary, a number of hours worked, a name of employee 222, an employee identifier, an amount of withholding for benefits, or other suitable information needed to perform payroll 204.

In one illustrative example, one or more technical solutions are present that overcome a technical problem with the complexity of configuring an information system to implement a policy in an organization. As a result, one or more technical solutions may provide a technical effect in which the running of a payroll in the organization may be performed more efficiently using at least one of payroll processor 216, policy instances 214, or execution units 226.

As a result, computer system 218 operates as a special purpose computer system in which at least one of payroll processor 216, policy instances 214, or execution units 226 in computer system 218 enables increased flexibility in running payroll 204. Additionally, the use of policy instances 214 with payroll processor 216 reduces the amount of program code that is needed in computer system 218 for running payroll 204. For example, different policy instances in policy instances 214 may use different ones of execution units 226. As a result, execution units 226 are not created for every one of policy instances 214 when running payroll 204 that only involves using a subset of policy instances 214. As depicted, execution units 226 may be selected and configured for each policy instance. This configuration may be performed each time execution units 226 are needed. After a policy instance has been used for running payroll and is no longer needed at the present time, those execution units may be removed from memory or stored for later use depending on the implementation. In this manner, memory is made available for other uses.

When the execution units are configured each time the execution units are needed, storage space is not needed because the execution units may be reconfigured each time and do not need to be saved. As a result, the amount of memory and storage in computer system 218 is reduced, as compared to having multiple payroll processing systems for different policies in which processes for performing calculations may be duplicated between the different payroll processing systems. In this manner, computer system 218 is a special purpose computer in which memory and storage in computer system 218 may be more efficiently used, as compared to currently used systems.

In another illustrative example, a directed acrylic graph (DAG) is used to run payroll 204. For example, a directed acrylic graph that identifies an order of executions is created. The order of executions is based on input and output dependencies in the execution units.

With this type of implementation, a single directed acrylic graph is created. As a result, running payroll 204 for employees 208 in organization 206 may be performed using a single directed acrylic graph. In this manner, time may be saved when payroll 204 is run using this type of implementation.

Further, in contrast to payroll systems that are hardcoded, a new directed acrylic draft may be created when changes in policies 210 are reflected in changes to policy instances 214. Then, a new payroll application may be compiled.

As a result, efficiency during runtime in running payroll 204 is present along with flexibility to take into account changes in policies 210 reflected in changes in policy instances 214. Thus, computer system 218 with payroll processing system 112 may be reconfigured more quickly as compared to computer systems that use currently hardcoded payroll processing applications and software.

Thus, at least one of payroll processor 216 or policy instances 214 transforms computer system 218 into a special purpose computer system as compared to currently available general computer systems that do not have at least one of payroll processor 216, policy instances 214, or execution units 226. For example, a technical problem with the time and effort needed to change or modify applications or other software for running payroll 204 when policies 210 within the organization change is overcome using one or more technical solutions for running payroll 204 using policy instances 214.

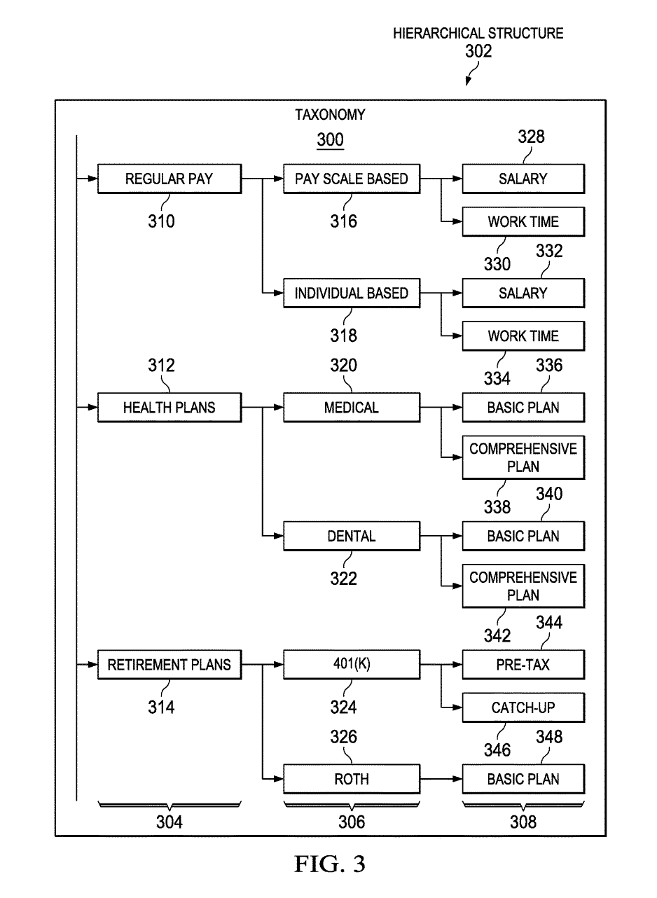

With reference next to FIG. 3, a block diagram of a taxonomy for payroll templates is depicted in accordance with an illustrative embodiment. In this illustrative example, taxonomy 300 is an example of an implementation for taxonomy 118 in FIG. 1.

As depicted, taxonomy 300 has hierarchical structure 302 in which policies are selected from hierarchical structure 302. In this example, hierarchical structure 302 has root level 304, level 306, and level 308.

Root level 302 has nodes in the form of regular pay 310, health plans 312, and retirement plans 314. In, level 306, pay scale based 316 and individual based 318 are child nodes with regular pay 310 as the parent node. Medical 320 and dental 322 are child nodes to health plans 312. As depicted, 401(k) 324 and Roth 326 are child nodes to retirement plans 314.

In level 308, the different nodes are leaf nodes and represent templates that may be selected. In level 308, salary 328 and work time 330 are child nodes to pay scale based 316. Salary 332 and work time 334 are child nodes to individual based 318. As depicted, basic plan 336 and comprehensive plan 338 are child nodes to medical 320. Basic plan 340 and comprehensive plan 342 are child nodes to dental 322. Pre-tax 344 and catch-up 346 are child nodes to 401(k) 324. Basic plan 348 is a child node to Roth 326.

The illustration of taxonomy 300 in FIG. 3 is provided as an example and not meant to limit the manner in which taxonomy 118 in FIG. 1 may be implemented. For example, taxonomy 300 may have other numbers of levels and numbers of nodes in the levels that may be followed to select policy templates for policies that are desired for implementation. Further, leaf nodes may be in other layers other than level 308 in other illustrative examples. As another example, taxonomy 300 may also include nodes to represent other payroll categories, such as international payroll categories, country categories, and other categories relating to an industry, a union, a location, or other suitable types of categories for running a payroll. Further, although taxonomy 300 is described in this illustrative example as having hierarchical structure 302, taxonomy 300 may be implemented using multiple trees, other structures, different views, or some combination thereof.

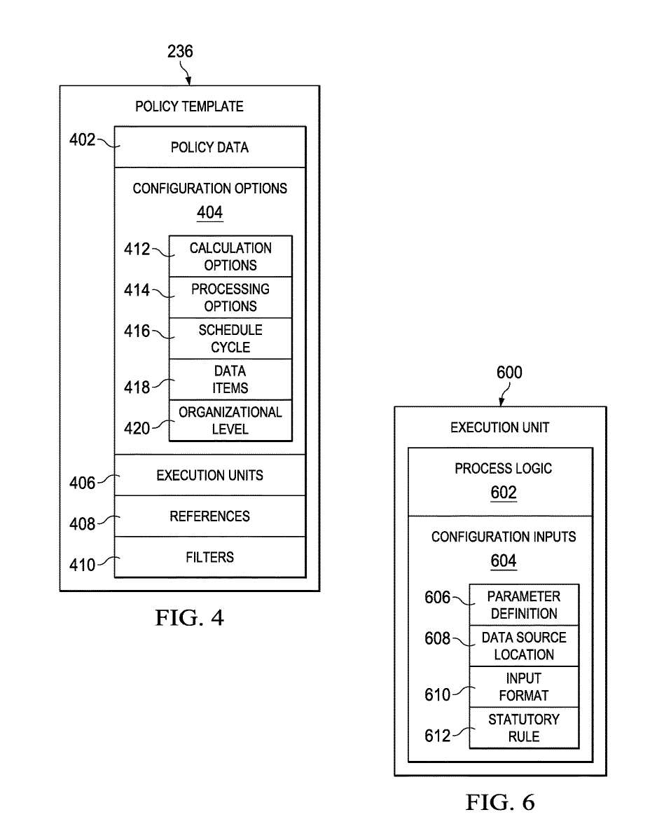

Turning next to FIG. 4, a block diagram of a template is depicted in accordance with an illustrative embodiment. An example of the implementation of policy template 236 in FIG. 2 is shown in this figure. In this illustrative example, policy template 236 has a number of different components. As depicted, policy template 236 includes policy data 402, configuration options 404, execution units 406, references 408, and filters 410.

Policy data 402 is data related to policy 232 in FIG. 2 for which policy template 236 is created. Policy data 402 includes at least one of a unique identifier, a description of the policy, a validity period, a version, or other suitable information.

Configuration options 404 are options that may be selected for implementing the policy for which policy template 236 is created in organization 206 in FIG. 2. Configuration options 404 include at least one of calculation options 412, processing options 414, schedule cycle 416, data items 418, and organizational level 420. As depicted, the selection of configuration options 404 form instance-specific information 228 in FIG. 2 for creating policy instance 220 in FIG. 2 from policy template 236.

In the illustrative example, calculation options 412 are different calculations that may be performed for policy 232 in FIG. 2 represented by policy template 236. Calculation options 412 may be implemented in execution units 226 in FIG. 2. For example, calculation options 412 may be whether the employer contribution is a percent match or is up to a certain amount with retirement benefits. These two options use different calculations. Selection of one of these calculation options results in a particular calculation being selected that is implemented in a particular execution unit in execution units 226.

As another example, calculation options 412 may be by employer or employee level. For example, when policy 232 in FIG. 2 as an employee level option is selected, the employee may select a type of contribution. For example, one employee may choose five percent while another employee may choose a certain amount.

As depicted, calculation options 412 may be represented in a number of different ways. For example, calculation options 412 may identify calculations performed by execution units 226 using at least one of identifiers, payroll classification codes, names, or other types of identification schemes.

The manner in which calculation options 412 may be selected is through the use of payroll classification codes. Different codes may indicate what types of calculations should be performed. An operator may select a desired payroll classification code that is known to the operator to identify calculation options 412. In this manner, the operator does not need to know which particular calculation options in calculation options 412 are needed. Instead, the operator may have knowledge of a type of payroll processing that is desired. The payroll classification code may be based off of currently used payroll codes for classifying payroll processing.

Further, payroll classification codes may influence the minimum number of execution units used in a policy instance for a policy. For example, a payroll classification code for a reimbursement policy may use a single execution unit to add to a net pay. On the other hand, the payroll classification code for a regular pay policy will require several execution units to calculate regular earnings, create gross pay, calculate benefit applicable earnings, and calculate tax applicable earnings.

In the illustrative example, processing options 414 are options that may be selected for performing calculations in calculation options 412. As depicted, processing options 414 include at least one of rounding, pro-rata calculations, retroactive behavior, or other options that may be used for performing calculations selected from calculation options 412. For example, rounding may include rounding up pay calculations while deductions are rounded down when performing calculations for running payroll.

Schedule cycle 416 defines when policy 232 in FIG. 2 is applied. For example, schedule cycle 416 may state that policy 232 is always applicable, define a group of periods of time when policy 232 is applicable, or identify events that result in the application of policy 232.

As another example, schedule cycle 416 may include at least one of a frequency cycle, a period selection, or worker elections. The frequency cycle may define how often a payroll is run. The frequency cycle may be, for example, weekly, biweekly, or monthly. In another example, the policy may be applied on a period selection, such as a first payroll period, a second payroll period, or some other payroll period. Further, an employee may elect when to apply the policy in schedule cycle 416.

Data items 418 identify data that is needed for calculations. Data items 418 may include an identification of parameters and sources of values for the parameters. Data items 418 may include data bindings to the sources of data. With data bindings, changes to the parameters at either a source or in the policy instance created from policy template 236 may be reflected in both the source of the data and policy instance 220 in FIG. 2.

For example, a data item in data items 418 may include how many hours an employee worked. In another example, the data item may be a number of miles driven for mileage reimbursements.

Organizational level 420 indicates how policy template 236 is to be applied. For example, policy template 236 may be applicable to an individual, a team, a department, an entire organization, or at some other level. In the list of examples, policy template 236 may be applicable to many different levels depending on how policy template 236 is defined.

As depicted, execution units 406 are groupings of program code that are used to perform calculations. Particular ones of execution units 406 used are based on which ones of calculation options 412 are selected.

In the illustrative example, the payroll classification code for execution units 406 may be identified in policy template 236. For example, execution units 406 may be identified through pointers, universal resource locations, unique identifiers, or other mechanisms for identifying execution units 406 that are in policy template 236. All or some of execution units 406 may be used when instance-specific information 228 in FIG. 2 is added to policy template 236 to form policy instance 220 in FIG. 2. The particular ones of execution units 406 used depends on the selection of calculation options 412 in this illustrative example.

References 408 are for information about policy 232 in FIG. 2. References 408 may include at least one of links, universal resource locators, pointers, or other mechanisms used to access the information.

As depicted, filters 410 are filters that can be applied during a search for policies. For example, filters 410 may include at least one of a country, an industry, a location, a union, or other items that may be used to filter the policies. Filters 410 allow an operator to more quickly find the policies that may be applicable to an organization.

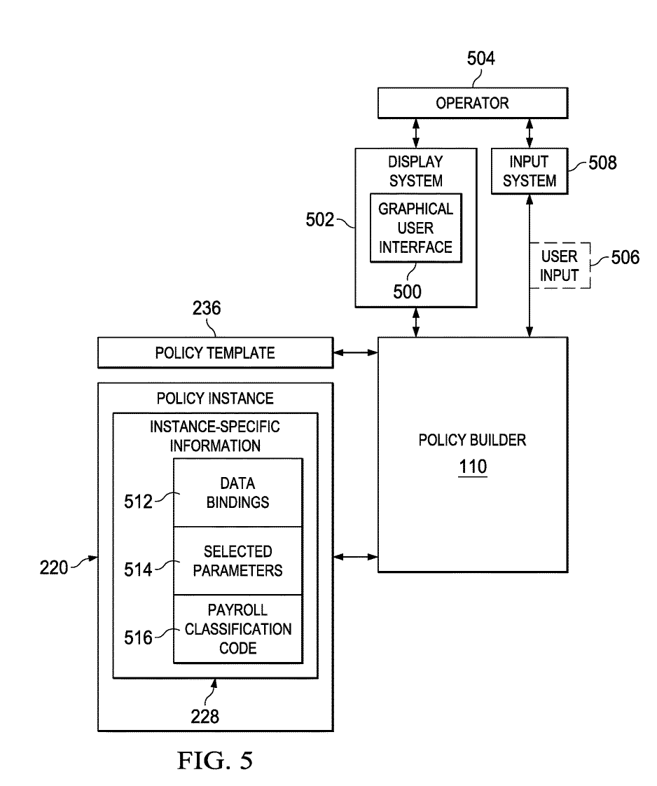

Turning next to FIG. 5, a block diagram of dataflow used to create a policy instance from a policy template is depicted in accordance with an illustrative embodiment. In this illustrative example, policy builder 110 operates to create policy instance 220 from policy template 236.

In this illustrative example, policy builder 110 displays user interface 122 in FIG. 1 in the form of graphical user interface 500 on display system 502 to operator 504. Display system 502 is a physical hardware system and includes one or more display devices on which graphical user interface 500 may be displayed. The display devices may include at least one of a light emitting diode (LED) display, a liquid crystal display (LCD), an organic light emitting diode (OLED) display, or some other suitable device on which graphical user interface 500 can be displayed.

Operator 504 is a person that may interact with graphical user interface 500 through user input 506 generated by input system 508 for policy builder 110, which includes a computer system. Input system 508 is a physical hardware system and may be selected from at least one of a mouse, a keyboard, a trackball, a touchscreen, a stylus, a motion sensing input device, a cyber glove, or some other suitable type of input device.

Graphical user interface 500 provides operator 504 an ability to see policy templates 212 in FIG. 2 and make selections from policy templates 212. The selections are made to implement desired policies in policies 210 in FIG. 2.

In this illustrative example, operator 504 has selected policy template 236 for use in creating policy instance 220 that is specific for organization 206 in FIG. 2. As depicted, the selection is made through user input 506 when operator 504 interacts with graphical user interface 500. Policy builder 110 creates a copy of policy template 236 that becomes policy instance 220. Policy instance 220 is created when the copy of policy template 236 includes instance-specific information 228 as input by operator 504 through user input 506 when interacting with graphical user interface 500.

As depicted, operator 504 generates user input 506 to create policy instance 220 from policy template 236. In this illustrative example, operator 504 generates user input 506 to select instance-specific information 228. The selection of instance-specific information 228 may include at least one of selecting or entering information for configuration options 404 in FIG. 4. In this illustrative example, the different steps performed by operator 504 implement policy instance 220 to follow a particular policy that is desired for organization 206 in FIG. 2.

In this particular example, instance-specific information 228 in policy instance 220 includes data bindings 512, selected parameters 514, and payroll classification code 516. As depicted, data bindings 512 are references to data items 418 in FIG. 4. Data bindings 512 identify sources of data 224 in FIG. 2 that are used for running a payroll.

Selected parameters 514 are parameters selected for processing options 414 in FIG. 4. For example, if policy instance 220 implements a policy for employer contributions for retirement benefits, selected parameters 514 may be a percentage or a certain amount that is used for identifying contributions. In this illustrative example, payroll classification code 516 is used to identify a group of execution units 226 in FIG. 2 that will perform calculations and other processing.

With reference next to FIG. 6, a block diagram of an execution unit is depicted in accordance with an illustrative embodiment. In this illustrative example, execution unit 600 is an example of an execution unit in execution units 226 in FIG. 2.

As depicted, execution unit 600 is software that runs on hardware, such as a processor unit in a computer system or other data processing system. As depicted, execution unit 600 comprises process logic 602 and configuration inputs 604.

Process logic 602 is program code that performs steps for calculations for a function in execution unit 600. For example, process logic 602 may include program the code that performs the function selected from one of a pay scale look-up, a pro-rata calculation, a mileage reimbursement, a car maintenance credit, or other types of functions used in running payroll 204 for organization 206 in FIG. 2.

In this illustrative example, configuration inputs 604 are at least one of program code configured or definitions that provide customization to process logic 602. For example, configuration inputs 604 include at least one of parameter definition 606, data source location 608, input format 610, statutory rule 612, or other suitable types of information that may be used to customize process logic 602.

Parameter definition 606 defines one or more parameters that are used by process logic 602. For example, process logic 602 may allow the use of three different parameters. Parameter definition 606 defines which ones of those three parameters are used by process logic 602.

In the list of examples, data source location 608 identifies a location of data that will be processed by process logic 602. Data source location 608 may take the form of pointers, links, data bindings, or other suitable mechanisms. Further, data source location 608 may include program code to query data sources to obtain the data for processing by process logic 602.

Input format 610 defines a format for the data that is obtained from data source location 608. Input format 610 may include program code to change the format of the data from data source location 608 used by process logic 602 if process logic 602 is unable to use the data in the format used by data source location 608.

Statutory rule 612 includes data or additional logic to handle statutory rules. For example, with 401(k) retirement benefits, statutory rule 612 may set limits to an amount of contribution in a year for employees. In this example, statutory rule 612 may not always be present for a particular policy.

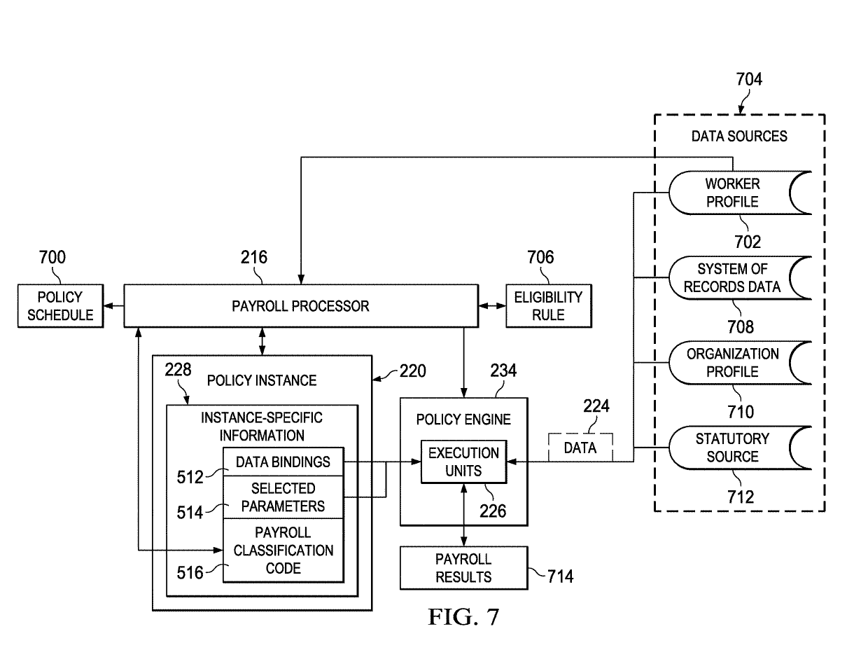

Turning next to FIG. 7, a block diagram of dataflow in running a payroll is depicted in accordance with an illustrative embodiment. In this illustrative example, payroll processor 216 identifies policy instance 220 for use in running payroll 204 in FIG. 2.

As depicted, payroll processor 216 identifies policy instance 220 from a group of policy instances 214 in FIG. 2 using policy schedule 700. Policy schedule 700 is a plan of when different ones of policy instances 214 should be used to implement policies 210 in FIG. 2 in organization 206 in FIG. 2 for running payroll 204. For example, policy schedule 700 may indicate that a policy instance in policy instances 214 should be applied during the running of payroll 204 on a first week of a month, on a second month of a year, once a year, monthly, on a particular date, or at some other time. Further, policy schedule 700 may include scheduling, such as schedule cycle 416 for policy template 236 in FIG. 4.

For example, some of policy instances 214 may be used daily, weekly, biweekly, monthly, or based on events depending on the policy that a particular policy instance implements. For example, a policy instance for employees 208 in FIG. 2 that are paid biweekly is run on a biweekly basis. As another example, the policy instance for employees 208 that are paid monthly is used once a month to run payroll 204 for those employees. In yet another example, policy schedule 700 may specify that a particular calculation for payroll 204 is made on a specific period, every other period, or on some other period.

As depicted, payroll processor 216 identifies which employee in employees 208 identified in worker profile 702 should be processed using policy instance 220. Worker profile 702 is a part of data sources 704. In this example, payroll processor 216 makes a determination of whether payroll 204 and the employee should be processed using eligibility rule 706.

For example, if policy instance 220 is for hourly employees and an employee in worker profile 702 is a salaried employee, then that employee is not eligible to be processed using policy instance 220. As another example, if policy instance 220 implements reimbursements for a company car policy for executives, then the employee who is not an executive in worker profile 702 is not eligible to be processed using policy instance 220.

When an employee identified in worker profile 702 is eligible for processing using policy instance 220, payroll processor 216 runs payroll 204 for the employee using policy instance 220. For example, payroll processor 216 uses payroll classification code 516 in instance-specific information 228 to identify a group of execution units 226 for policy instance 220 using payroll classification code 516 in instance-specific information 228 for policy instance 220.

A payroll classification code for a base pay may include execution units 226 for base pay, gross pay, benefits, and taxes. The payroll classification code for a deduction may include execution units 226 for taxes and net pay. The group of execution units 226 identified for policy instance 220 from payroll classification code 516 forms policy engine 234.

In this example, the group of execution units 226 in policy engine 234 uses data bindings 512 and selected parameters 514 as inputs to run payroll 204. In other words, data bindings 512 and selected parameters 514 in instance-specific information 228 are used to configure the group of execution units 226.

The group of execution units 226 uses data bindings 512 to identify data sources 704 that are used to run payroll 204 with policy instance 220. For example, data bindings 512 may include pointers, universal resource locators, or other suitable mechanisms to be able to access data sources 704. As depicted, data sources 704 include worker profile 702, system of records (SOR) data 708, organization profile 710, and statutory source 712.

Worker profile 702 includes information, such as name, address, Social Security number, location, pay type, and other information. System of records data 708 is a data source that is external to payroll processing system 112 in FIG. 1. For example, system of records data 708 may be from a time tracking system, a benefits system, a human resources system, or some other system that is located in or used by organization 206 in FIG. 2.

Organization profile 710 is information about how organization 206 is organized. For example, organization profile 710 indicates that organization 206 includes a company match for 401(k) retirement accounts that is up to four percent. As another example, organization profile 710 may include the amount of reimbursements for allowances for company cars.

Statutory source 712 includes statutory rules that may be applicable to the policy that is implemented when processing policy instance 220. These different sources of information in data sources 704 provide data 224 as input into the group of execution units 226 to generate payroll results 714 in the running of payroll 204 in FIG. 2 for organization 206.

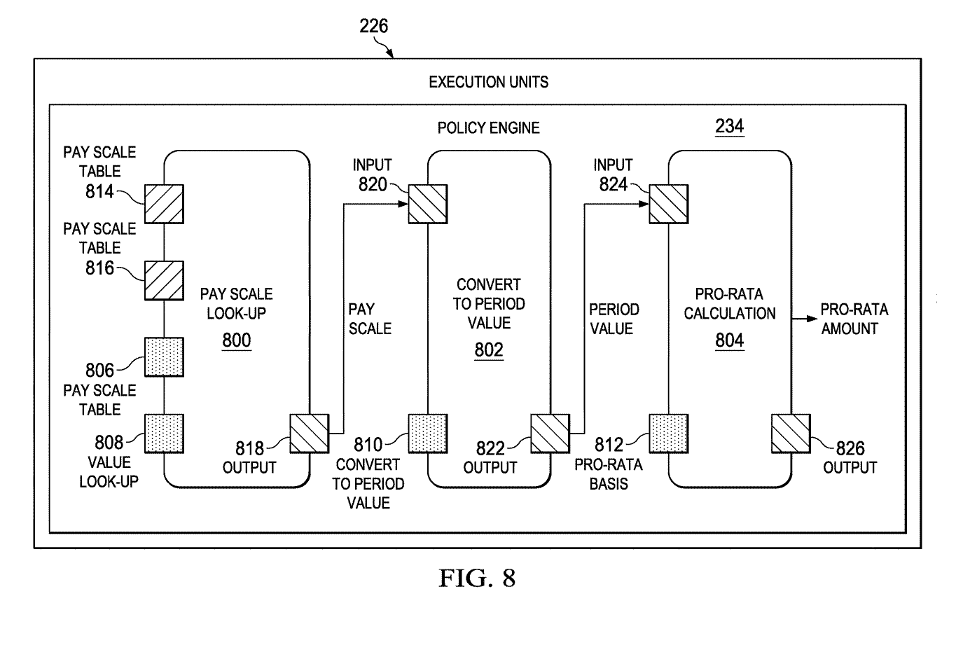

With reference now to FIG. 8, an illustration of a policy engine is depicted in accordance with an illustrative embodiment. In this illustrative example, an example of one implementation of policy engine 234 is shown. As depicted, policy engine 234 is for a regular pay based on a pay scale. A group of execution units 226 and policy engine 234 include pay scale look-up 800, convert to period value 802, and pro-rata calculation 804. As seen in this example, pay scale look-up 800, convert to period value 802, and pro-rata calculation 804 are examples of processing options 414 in FIG. 4. Pay scale table 814 and pay scale table 816 are data bindings and examples of data items 418 in FIG. 4.

As depicted, data is input into policy engine 234 at pay scale look-up 800. The input from sources defined by data bindings includes pay scale table 814 and pay scale table 816. Pay scale table 806 is a processing option that identifies the fields that are obtained from the data sources, pay scale table 814 and pay scale table 816. Value look-up 808 is a processing option to look up a value from the pay scale tables, pay scale table 814 and pay scale table 816.

Pay scale look-up 800 identifies the pay scale for an employee from data sources by the data bindings. As depicted, the pay scale is an annual salary. This identification of the pay scale is output by pay scale look-up 800 at output 818, which is connected to input 820 for convert to period value 802.

In this illustrative example, convert to period value 810 is a processing option that indicates that the pay scale is to be converted to an amount for the period used for the employee. For example, if the period is monthly, the pay scale is divided by 12 to obtain the period value. If the period is biweekly, the pay scale is divided by 26 to obtain the period value.

The resulting period value is output by convert to period value 802 at output 822, which is connected to input 824 for pro-rata calculation 804. In this example, pro-rata calculation 804 identifies a pro-rata amount from the period value. Pro-rata basis 812 is a processing option that defines how partial periods are calculated. For example, pro-rata basis 812 may define how to calculate a salary amount if an employee joins an organization in the middle of a payroll period. Pro-rata calculation 804 may be based on work days, work hours, calendar days, but also may be based on different factors.

As depicted, the pro-rata amount may be identified based on a number of work hours for the employee in the payroll. This pro-rata amount is output by pro-rata calculation 804 at output 826.

The illustration of policy framework 100 in FIG. 1 and the different components and examples of implementations in FIGS. 1-8 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, a group of execution units 226 in FIG. 2 runs on a first thread, wherein payroll processor 216 in FIG. 2 processes additional data in a group of additional execution units running on a second thread to run payroll 204 in FIG. 2 for an additional employee. In this manner, computer system 218 in FIG. 2 is a special purpose computer in which a payroll may be run for multiple employees at substantially the same time using multiple threads that are executed concurrently on a single processor core or multiple processor cores in a processor unit. In yet another illustrative example, the group of execution units 226 for a first policy instance runs on the first thread for a first feature, wherein payroll processor 216 processes additional data in the group of additional execution units for a second policy instance running on the second thread to run payroll 204.

The first policy instance and the second policy instance are for different policies in policies 210 in FIG. 2 for organization 206 in FIG. 2. For example, the first policy instance may be for reimbursements while the second policy instance may be for overtime. In this manner, running of the payroll may be performed more quickly through concurrent processing of different policies. This type of processing may occur depending on dependencies between different policies that may be applied for a particular payroll. In other examples, three or more threads may be present for three or more employees, groups of employees, or policies.

In another illustrative example, statutory rules may be included as a part of instance-specific information 228 in FIG. 4 rather than being received from a data source. In other illustrative examples, program code for execution units 406 in FIG. 4 may be included in policy template 236 in FIG. 2.

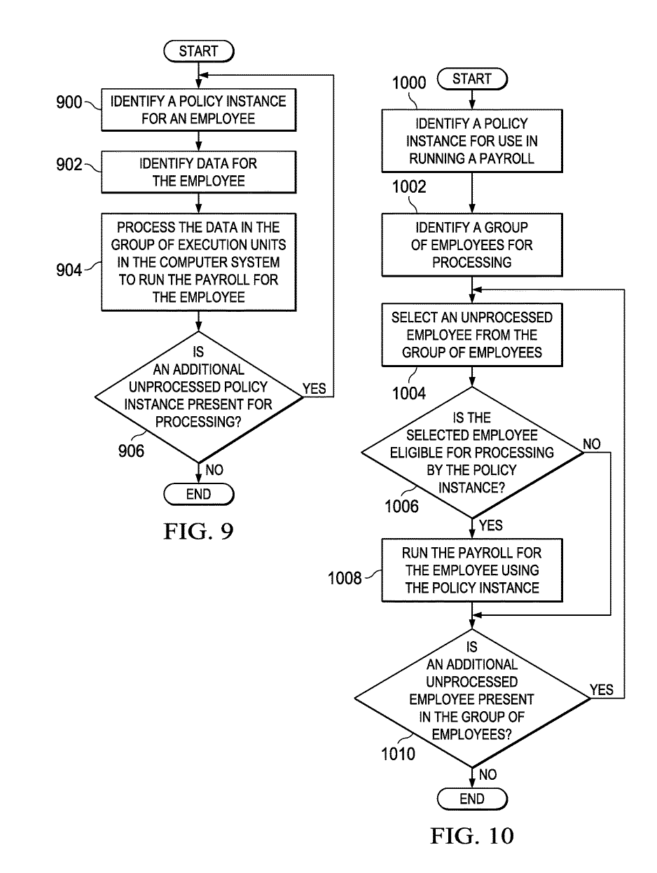

Turning next to FIG. 9, a flowchart of a process for running a payroll is depicted in accordance with an illustrative embodiment. The process in FIG. 9 may be implemented in payroll processor 216 in FIG. 2. For example, these different steps may be implemented using program code.

The process begins by identifying a policy instance for an employee (step 900). In the illustrative example, more than one policy instance may be present for processing. In that case, step 900 identifies the policy instance has not yet been processed. As depicted, the policy instance implements a policy when running a payroll.

As depicted, step 900 may be performed by selecting the employee and then locating the policy instance. In other illustrative examples, the policy instance may be selected for processing and then the employee may be identified as eligible for processing using the policy instance. The policy instance includes a group of execution units in a computer system that implements a group of rules for a policy with respect to running the payroll for the organization.

The process identifies data for the employee (step 902). The data in the group of execution units is processed in the computer system to run the payroll for the employee (step 904). The group of execution units is configured with instance-specific information for the policy instance to process the data for the payroll using the group of rules for the policy.

A determination is made as to whether an additional unprocessed policy instance is present for processing (step 906). If another unprocessed policy instance is present, the process returns to step 900. If another unprocessed policy instance is not present, the process terminates.

In this manner, the process may be repeated until all of the policy instances that are applicable have been processed for running the payroll. Thus, all policy instances that are relevant to the employee may be applied.

With reference next to FIG. 10, a more detailed flowchart of a process for running a payroll is depicted in accordance with an illustrative embodiment. The process illustrated in this figure may be implemented using payroll processor to 216 in FIG. 2.

The process begins by identifying a policy instance for use in running a payroll (step 1000). This identification may be made based on a policy schedule that indicates when a particular policy instance should be used when running the payroll.

The process then identifies a group of employees for processing (step 1002). The process selects an unprocessed employee from the group of employees (step 1004).

A determination is made as to whether the selected employee is eligible for processing by the policy instance (step 1006). This determination may be made based on information about the employee and rules that determine when the policy instances are applicable to the employee.

If the selected employee is eligible for processing by the policy instance, the process runs the payroll for the employee using the policy instance (step 1008). The process then determines whether an additional unprocessed employee is present in the group of employees (step 1010). If an additional unprocessed employee is present, the process returns to step 1004. Otherwise, the process terminates. With reference again to step 1006, if the employee is not eligible for processing, the process proceeds to step 1010 as described above.

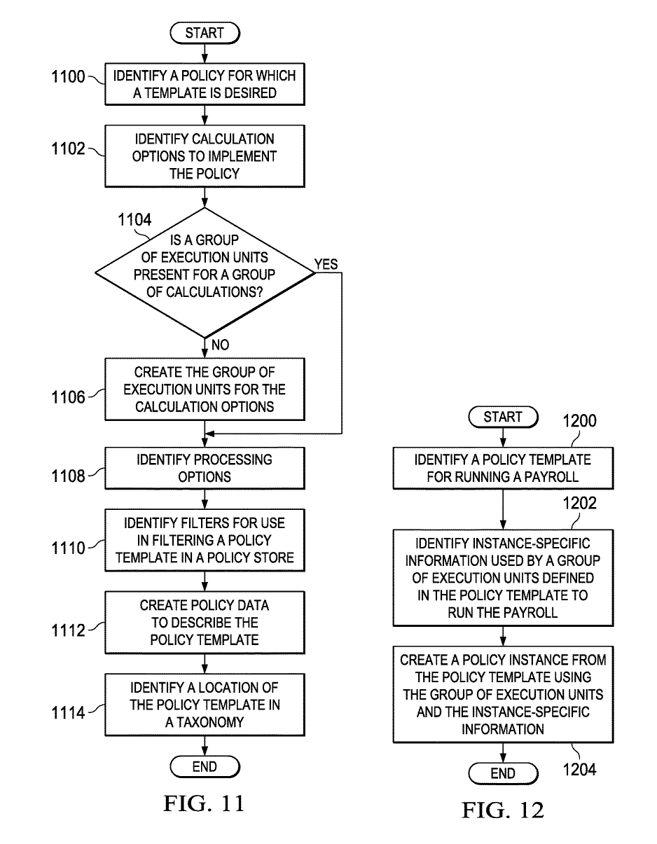

With reference now to FIG. 11, a flowchart of a process for creating a template is depicted in accordance with an illustrative embodiment. The process illustrated in FIG. 11 may be implemented using policy designer 106 in FIG. 1.

The process begins by identifying a policy for which a template is desired (step 1100). For example, the policy may be maintenance for a car policy, credits for a uniform policy, or some other suitable feature to implement the policy in an organization.

The process identifies calculation options to implement the policy (step 1102). The process determines whether a group of execution units is present for a group of calculations (step 1104). In step 1104, the group of execution units is considered to be absent if one execution unit in the group of execution units is not present.

If the group of execution units is not present, the process creates the group of execution units for the calculation options (step 1106). The execution units created are for any execution units that are missing from the group of execution units that are desired for the calculation.

The process identifies processing options (step 1108). The process then identifies filters for use in filtering a policy template in a policy store (step 1110). The process then creates policy data to describe the policy template (step 1112). The process then identifies a location of the policy template in a taxonomy (step 1114) with the process terminating thereafter.

With reference again to step 1104, the process proceeds directly to step 1108 if the group of execution units is present. The policy template created may then be used to create policy instances to implement the feature represented by the policy template.

One or more of the steps in the flowchart in FIG. 11 may be performed by a human operator interacting with policy designer 106 in FIG. 1. For example, the human operator may interact with policy designer 106 to create program code for the group of execution units.

With reference next to FIG. 12, a flowchart of a process for creating a policy instance is depicted in accordance with an illustrative embodiment. The process illustrated in FIG. 12 may be implemented using policy builder 110 in FIG. 1 and FIG. 5.

The process begins by identifying a policy template for a policy for running a payroll (step 1200). The process identifies instance-specific information used by a group of execution units defined in the policy template to run the payroll (step 1202).

The process creates a policy instance from the policy template using the group of execution units and the instance-specific information (step 1204) with the process terminating thereafter. The policy instance is used to run the payroll for an employee.

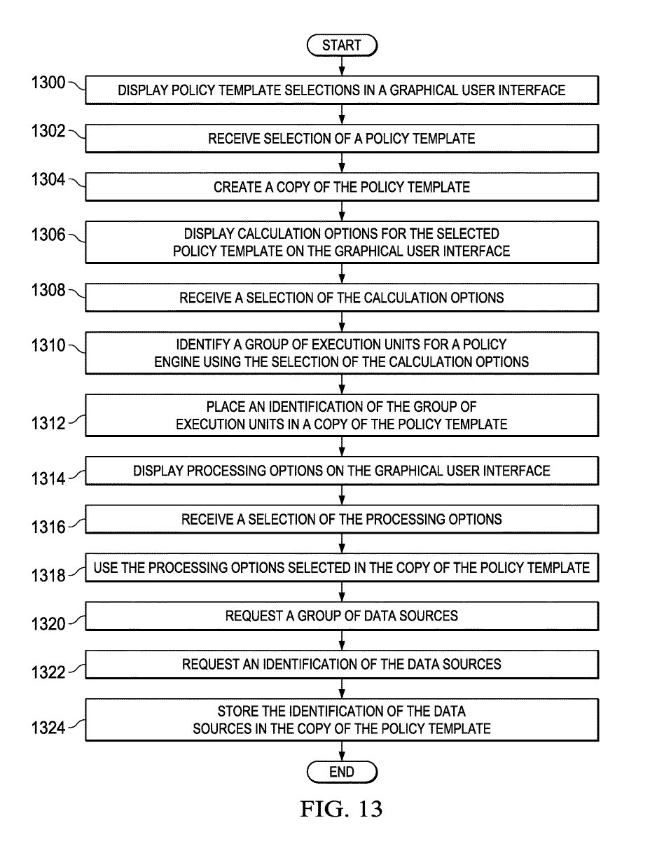

Turning next to FIG. 13, a more detailed flowchart of a process for creating a policy instance is depicted in accordance with an illustrative embodiment. The process illustrated in FIG. 13 may be implemented using policy builder 110 in FIG. 1 and FIG. 5.

The process begins by displaying policy template selections in a graphical user interface (step 1300). The policy template selections are policy templates that may be selected for use in implementing a policy.

The process receives selection of a policy template (step 1302). The selection is made through user input from an operator.

The process creates a copy of the policy template (step 1304). This copy of the policy template is used to form the policy instance. In other words, information may be placed into the policy template to form a policy instance.

The process displays calculation options for the selected policy template on the graphical user interface (step 1306). These options may be presented in a number of different ways. For example, a description of the different calculation options that can be used may be displayed on the graphical user interface. In another illustrative example, payroll classification codes may be displayed for the operator to select.

The process receives a selection of the calculation options (step 1308). The process identifies a group of execution units for a policy engine using the selection of the calculation options (step 1310). The process places an identification of the group of execution units in a copy of the policy template (step 1312).

The process displays processing options on the graphical user interface (step 1314). The process receives a selection of the processing options (step 1316) and uses the processing options selected in the copy of the policy template (step 1318). Other options not selected are not included in the copy of the template in step 1318. These processing options are used to select parameters, values of parameters, sources for data items, or other suitable information needed to implement the options selected.

The process then requests a group of data sources (step 1320). The group of data sources is one or more data sources that provide data for use by the policy instance. The process requests an identification of the data sources (step 1322) and stores the identification of the data sources in the copy of the policy template (step 1324). The process terminates thereafter. At this time, the copy of the policy template becomes the policy instance that may be used during the running of a payroll.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, steps 1308, 1310, and 1312 may be performed after steps 1314, 1316, and 1318. In another example, steps 1320, 1322, and 1324 may be omitted. The data sources may be preset for the policy instance.

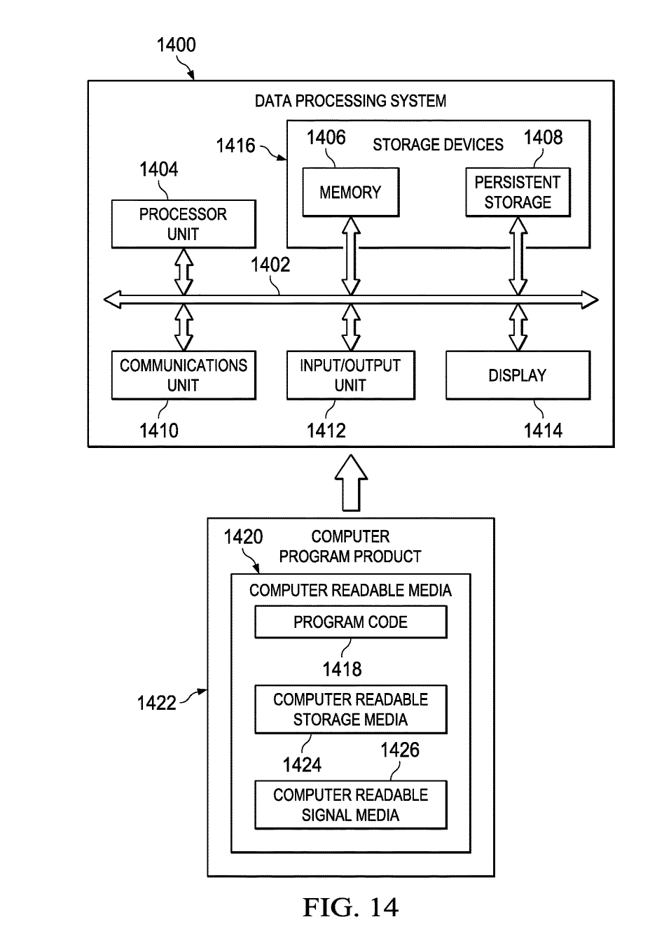

Turning now to FIG. 14, a block diagram of a data processing system is depicted in accordance with an illustrative embodiment. Data processing system 1400 may be used to implement policy designer 106, policy store 108, policy builder 110, payroll processing system 112, computer system 218 in FIG. 2, and other data processing systems that may be used in policy framework 100 in FIG. 1 or information environment 200 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 may take the form of a bus system.

Processor unit 1404 serves to execute instructions for software that may be loaded into memory 1406. Processor unit 1404 may be a number of processors, a multi-processor core, or some other type of processor, depending on the particular implementation.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer readable storage devices in these illustrative examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a solid state hard drive, a flash memory, a rewritable optical disk, a rewritable magnetic tape, or some combination of the above. The media used by persistent storage 1408 also may be removable. For example, a removable hard drive may be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that may be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs may be located in storage devices 1416, which are in communication with processor unit 1404 through communications framework 1402. The processes of the different embodiments may be performed by processor unit 1404 using computer-implemented instructions, which may be located in a memory, such as memory 1406.

These instructions are referred to as program code, computer usable program code, or computer readable program code that may be read and executed by a processor in processor unit 1404. The program code in the different embodiments may be embodied on different physical or computer readable storage media, such as memory 1406 or persistent storage 1408.

Program code 1418 is located in a functional form on computer readable media 1420 that is selectively removable and may be loaded onto or transferred to data processing system 1400 for execution by processor unit 1404. Program code 1418 and computer readable media 1420 form computer program product 1422 in these illustrative examples. In one example, computer readable media 1420 may be computer readable storage media 1424 or computer readable signal media 1426.

In these illustrative examples, computer readable storage media 1424 is a physical or tangible storage device used to store program code 1418 rather than a medium that propagates or transmits program code 1418.

Alternatively, program code 1418 may be transferred to data processing system 1400 using computer readable signal media 1426. Computer readable signal media 1426 may be, for example, a propagated data signal containing program code 1418. For example, computer readable signal media 1426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1400 are not meant to provide architectural limitations to the manner in which different embodiments may be implemented. The different illustrative embodiments may be implemented in a data processing system including components in addition to or in place of those illustrated for data processing system 1400. Other components shown in FIG. 14 can be varied from the illustrative examples shown. The different embodiments may be implemented using any hardware device or system capable of running program code 1418.

Thus, one or more of the illustrative examples provide a method and apparatus to overcome the complexities and time needed to implement policies in processing a payroll for an organization. One or more illustrative examples provide a technical solution that involves using policy templates that can be instantiated as policy instances to implement policies when running the payroll for the organization. The use of these policy templates reduces the amount of time needed to implement the policies in a payroll system.

The implementation of the policies using the policy templates provides an ability to implement the policies within the organization more easily as compared to current systems. For example, with each policy being implemented using a policy template, a change in one policy may be implemented through a policy template change to the policy template for the policy while other policies are unaffected. Current payroll systems require an update that may need testing generally. Testing the entire payroll system takes more time and effort than testing the change in a single policy through the change in the policy template. For example, the testing may include simulating policy input parameters to perform a test run of the policy after the change is made to the policy instance. This type of testing may make implementing changes to the payroll system for running the payroll to reflect the changes in the policy easier and more quickly to perform as compared to currently used payroll systems.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A payroll processing system comprising:
a group of policy instances, wherein the group of policy instances implements a group of rules for a group of policies used for running a payroll for an organization; and
a payroll processor that selects a policy instance from the group of policy instances for running the payroll; identifies data for an employee for use in running the payroll; and processes the data in a group of execution units in the policy instance, wherein the group of execution units is configured with instance-specific information for the policy instance to process the data for the payroll using the group of rules for a policy implemented using the policy instance.

2. The payroll processing system of claim 1, wherein the instance-specific information comprises at least one of a parameter, a table, a database, a value, a formula, a policy data model, or a statutory rule.

3. The payroll processing system of claim 1 further comprising:
a group of policy templates, wherein the policy instance is formed from a policy template in the group of policy templates using the instance-specific information.

4. The payroll processing system of claim 1, the group of execution units forms a policy engine that implements the group of rules for the policy for running the payroll.

5. The payroll processing system of claim 1, wherein the group of execution units comprises program code in a device-specific language.

6. The payroll processing system of claim 1, wherein the group of execution units runs on a first thread and wherein the payroll processor processes additional data in a group of additional execution units running on a second thread to run the payroll for an additional employee.

7. The payroll processing system of claim 1, wherein the policy is selected from one of a uniform policy, a regular pay policy, a union policy, a retirement savings policy, a pension policy and an overtime policy.

8. The payroll processing system of claim 1, wherein the payroll processor selects the policy instance using at least one of an identification of the employee or a group to which the employee belongs.

9. The payroll processing system of claim 1, wherein the organization is selected from one of a company, a partnership, a charity, an educational group, a social group, a team, a city, or a government agency.

10. A method for running a payroll, the method comprising:
identifying, by a computer system, a policy instance for an employee, wherein the policy instance includes a group of execution units in the computer system that implements a group of rules for a policy with respect to running the payroll for an organization;
identifying, by the computer system, data for the employee; and
processing the data in the group of execution units in the computer system to run the payroll for the employee, wherein the group of execution units is configured with instance-specific information for the policy instance to process the data for the payroll using the group of rules for the policy.

11. The method of claim 10, wherein the instance-specific information comprises at least one of a parameter, a table, a database, a value, a formula, a policy data model, or a statutory rule.

12. The method of claim 10 further comprising:
configuring the group of execution units using the instance-specific information, wherein the group of execution units forms a policy engine that implements the group of rules for the policy to run the payroll.

13. The method of claim 10, wherein the group of execution units runs a first thread and further comprising:
processing additional data in a group of additional execution units running on a second thread to run the payroll for an additional employee.

14. The method of claim 10, wherein the group of execution units comprises program code in a device-specific language.

15. The method of claim 10, wherein the instance-specific information is selected from at least one of a uniform policy, a regular pay policy, a union policy, a retirement savings policy, a pension policy and an overtime policy.

16. The method of claim 10, wherein the organization is selected from one of a company, a partnership, a charity, an educational group, a social group, a team, a city, a group of employees, a union, or a government agency.

17. A method for creating a policy instance for running a payroll, the method comprising:
identifying a policy template for a policy for running the payroll;
identifying instance-specific information used by a group of execution units defined in the policy template to process the payroll; and
creating the policy instance from the policy template using the group of execution units and the instance-specific information, wherein the policy instance is used to run the payroll for an employee.

18. The method of claim 17, wherein the instance-specific information is selected from at least one of a parameter, a table, a database, a value, a formula, a policy data model, or a statutory rule.

19. A computer program product for running a payroll, the computer program product comprising:
a computer readable storage media;
first program code, stored on the computer readable storage media, for identifying a policy instance for an employee, wherein the policy instance includes a group of execution units in a computer system that implements a group of rules for a policy with respect to running the payroll for an organization;
second program code, stored on the computer readable storage media, for identifying data for the employee; and
third program code, stored on the computer readable storage media, for processing the data in the group of execution units to run the payroll for the employee, wherein the group of execution units is configured with instance-specific information for the policy instance to process the data for the payroll using the group of rules for the policy.

20. The computer program product of claim 19, wherein the instance-specific information comprises at least one of a parameter, a table, a database, a value, a formula, a policy data model, or a statutory rule.

21. The computer program product of claim 19 further comprising:
fourth program code, stored on the computer readable storage media, for configuring the group of execution units using instance-specific information, wherein the group of execution units forms a policy engine that implements the group of rules for the policy to run the payroll.

22. The computer program product of claim 19, wherein the group of execution units runs a first thread and further comprising:
fourth program code, stored on the computer readable storage media, for processing additional data in a group of additional execution units running on a second thread to run the payroll for an additional employee.

23. The computer program product of claim 19, wherein the group of execution units comprises program code in a device-specific language.

24. The computer program product of claim 19, wherein the instance-specific information is selected from at least one of a uniform policy, a regular pay policy, a union policy, a retirement savings policy, a pension policy and an overtime policy.

25. The computer program product of claim 19, wherein the organization is selected from one of a company, a partnership, a charity, an educational group, a social group, a team, a city, or a government agency.
